(19) United States
(12) Patent Application Publication
(10) Pub. No.: US 2005/0177486 A1
(43) Pub. Date: Aug. 11, 2005

(54) Method and apparatus for aggregating and disseminating user activity data in online auctions

(76) Inventor: Wayne Bell Yeager, Lexington, KY (US)

Correspondence Address: WAYNE YEAGER, 3777 DICKSONIA DRIVE, LEXINGTON, KY, 40517, US

(21) Appl. No.: 10/946,856

(22) Filed: Sep. 21, 2004

Related U.S. Application Data
(60) Provisional application No. 60/504,937, filed on Sep. 23, 2003.

(51) Int. Cl. G06F 17/60

(52) U.S. Cl. 705/37

(57) ABSTRACT

A method of recording and aggregating data related to visitor activity in an online auction environment, and of providing that data to a plurarity of online auction sellers for the purpose of improving the marketing of their online auctions. The present invention is comprised of computer programming code embedded in an online auction page, a dynamic tracking computer program that resides on a web server that receives and logs the data transmitted by said embedded code, and a computer program that resides on a web server that interprets and assembles the logged data into activity reports for auction sellers. Such reports include most and least popular search terms, most and least popular search variables, most and least popular item categories, most and least popular search terms within specific categories, most and least popular sorting methods, most and least popular days of the week, most and least popular times of the day, and others, including the rise and fall of the popularity of said search terms, categories, variables and methods over time.

This application claims the benefit of U.S. Provisional Application No. 60/504,937, filed on Sep. 23, 2003.

### FIELD OF THE INVENTION

The present invention relates generally to online auctions and more specifically it relates to a method of aggregating searching data and browsing patterns of online auction users and reporting that data to online auction sellers for the purpose of improving their future offerings.

### BACKGROUND OF THE INVENTION

Prior to the present inventor's Provisional Patent Application entitled “System and Method for Tracking Online Auction Visitors” (U.S. Provisional Application No. 60/497,719), access to information regarding precisely how a specific online auction visitor found a specific auction was limited to employees of the auction venue itself. Even if the data could be mined from the logfiles of the auction venue's web server(s) by third parties, it would require both the cooperation of the auction venue, and even, perhaps, the community of online auction users who may balk at such a request out of concerns for their personal privacy.

But the Provisional Patent Application cited above (U.S. Provisional Application No. 60/497,719) disclosed a method that enables online auction sellers to know how visitors find the sellers' online auctions, including the keyword(s) the visitors search for, the categories the visitors browse, and the manner in which the visitor sorts the search and/or browsing results. Furthermore, the aforementioned Provisional Patent Application disclosed such a method that does not require access to the auction venue's files, nor reveal personal details about the visitors.

Consequently, since there existed no method for accessing this data by online auction sellers or third parties prior to the aforementioned Provisional Patent Application (U.S. Provisional Application No. 60/497,719), prior art related to the aggregation and dissemination of this data is, naturally, absent.

When considered as prior art relative to the present invention, the present inventor's aforementioned previous Provisional Patent Application, “System and Method for Tracking Online Auction Visitors” (U.S. Provisional Application No. 60/497,719), provides only for search and browsing data for individual auctions of individual sellers, and is thus limited in scope. The present invention allows other online auction sellers to determine the best way to title and/or describe their items for sale—and improve their pricing strategy—by virtue of examining auction user activity in the aggregate.

Prior art exists in the area of aggregating and disseminating certain sales-related data from online auctions, including information related to . . .
the item for sale
whether or not the item for sale was successfully sold
if so, the final price
the number of bids the item for sale received
geographic location of the buyer
time and date of sale

. . . and other data specifically related to the sale of the item. But no prior art exists in the area of aggregating and disseminating the search data that allowed the visitors to find the auction in the first place, or any other user activity data.

The primary problem with this form of prior art is that it does not provide online auction sellers with any information that would enable them to attract more visitors to their online auctions. While sales data may be useful in helping the online auction seller determine a selling price, or which items he should be selling, it does not provide any information on the method potential buyers use to find these items for sale.

Prior art also exists in the area of aggregating and disseminating popular search terms on websites, typically search engines and portals providing search functionality. While it's important to note that this search data is limited to searches performed by those merely interested in the subject matter, and not by those actively seeking an item in an online auction environment, the chief difference between the prior art and the present invention is the present invention gives the online auction seller the ability to obtain this data from a website he does not own or control, more specifically from an online auction website.

Most webservers utilize software that logs the activity of each visitor. But this data is available only to those who have access to the webserver's logfiles, typically the webmaster or systems administrator of the particular website. The present invention allows users—as opposed to owners—of a website (and in the preferred embodiment, the user in this example would be an online auction seller) to gain access to data related to their specific auction page without any intervention or assistance from the website owner, webmaster or systems administrator.

The main problem with this form of prior art, therefore, is that it does not provide any data related to what online auction buyers are searching for. The prior art may be of some value to have general knowledge of what the internet population at large is searching for, but online auction sellers need data as it specifically relates to the online auction environment.

In these respects, the method of aggregating and disseminating search data of online auction visitors according to the present invention substantially departs from the conventional concepts and methods of the prior art, and in so doing, provides a system for online auction sellers to know which keywords and phrases have historically been most often used by potential buyers when attempting to locate particular items on online auction sites. It also provides sellers with an overview of other online auction user activity including most active days of the week, most active times of the day, most popular methods of sorting auction listings, and others.

### SUMMARY OF THE INVENTION

Online auctions have become a major component of ecommerce, with billions of dollars in transactions being conducted each quarter. While most online auction users are only occasional sellers, a significant portion of online auction users are advanced, professional and even full-time sellers who depend on online auctions for much—if not all—of their sales revenue.

Success in business is often dependent on the availability of data for decision-making purposes, and the availability of online auction search data has, heretofore, been non-existent. Without knowing how online auction users typically find the specific items they're looking for, online auction sellers must resort to guesswork when titling and describing their items for sale.

The present invention provides a method by which online auction sellers can obtain valuable marketing data related to online auction user activity, including the most popular keyword searches for the item or items the seller wishes to offer, the most popular categories that browsers find such item or items in, the most active times of the day when potential buyers seek such items, the most active days of the week when potential buyers seek such items, the most popular methods for sorting auction listing results, and other useful data.

The general purpose of the present invention, which will be described subsequently in greater detail, is to provide online auction sellers with a means to increase the number of visitors to their online auctions by taking advantage of information related to actual online auction visitor searching and browsing activity, and by doing so in a way that is not anticipated, rendered obvious, suggested or even implied by any of the prior art, either alone or in any combination thereof.

To attain this, the present invention generally comprises a network of online auction users, each with computer programming code embedded in their online auction listings which retrieves information related to the referring document (which contains the relevant search data) each time the web page is loaded, and delivers this data to a web server. This data is compiled from all users and aggregated into an online database storing said user activity data in such a way that the most common activity traits can be determined. Sellers who subscribe to said online database can monitor user activity patterns to determine the most common user activity patterns related to the seller's item or items. Additionally, sellers can monitor this user activity to gauge the rise and fall of relevant activity patterns over time.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining the preferred embodiment of the invention in detail, it is understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide online auction sellers with information related to the most popular keywords, search parameters and other variables used by online auction buyers to find specific items on online auction sites.

An object of the present invention is to provide data to online auction sellers sufficient to improve their marketing decisions as they relate to online auctions.

Another object is to enable online auction sellers to determine the most popular category or categories auction visitors browse (or search in) when attempting to locate specific items on an online auction site.

Another object is to enable online auction sellers to determine which search variables, range of variables and type of variables are the most often used when attempting to locate specific items on an online auction site.

Another object is to enable online auction sellers to determine the most popular methods of sorting online auction listings, such as “high price to low price”, “newly listed items”, etc.

Another object is to enable online auction sellers to determine the most active time of day, and most active day of the week, when potential buyers are attempting to locate a specific item on an online auction site.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction and design illustrated.

### BRIEF DESCRIPTION OF THE DRAWING

Various other objects, features and attendant advantages of the present invention will become fully appreciated as the same becomes better understood when considered in conjunction with the accompanying drawing, wherein:

FIG. 1 is a diagram illustrating the method employed by the present invention to disseminate aggregated online auction search data for online a uction sellers.

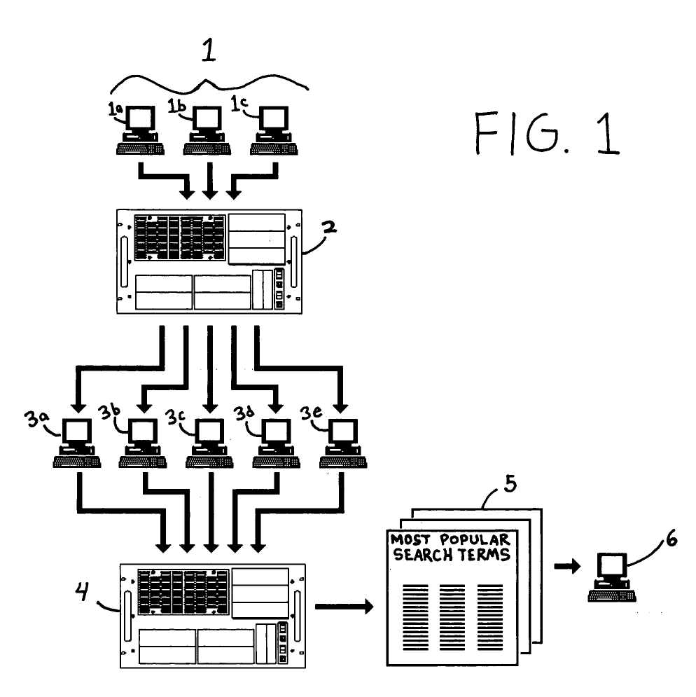

### DETAILED DESCRIPTION OF THE INVENTION

Turning now descriptively to the drawing, the attached FIGURE illustrates a method of recording data from online auction visitors which comprises computer software code for gathering the data, a method of storing the retrieved data on a computer server connected to the world wide web, and a method of aggregating and disseminating the data to a plurality of online auction sellers.

After online auction sellers 1 create the titles and descriptions for the items they wish to sell on online auctions, they upload that data, along with photographs or other illustrative information, to the online auction venue's web server 2, which makes the auction details available to the online auction buyers 3(a-h) who can download the information from the auction venue's web server 2.

When the online auction sellers 1 create the descriptive data for the items they wish to sell, they typically do so in HTML, the computer markup language most often used to generate websites.

Inside HTML, scripting code (such as JavaScript or VBscript) can be inserted to perform certain tasks that standard HTML, at present, cannot. One of these tasks is retrieving the “Referring Document” information, which contains the URL of the last page visited. Scripting languages can also be used to “write” information into the auction description page based on a set of instructions. And in the present invention, this feature of scripting languages is used to insert a link that accesses an external script and provides that script with the Referring Document data.

The following code is written in Javascript, but any scripting language will suffice. The following code, when placed inside an HTML page, will retrieve the Referring Document (the URL of the last web page the visitor viewed immediately prior to coming to the current web page) and assign that value to the variable “referringpage”.

<script language = “JavaScript”>
var referringpage = escape(document.referrer);
var maindomain = “http://www.domain.com/”;
document.write(“<img src=\“” + maindomain +
“cgi-bin/track.cgi?l=” + referringpage + “\” height=1 width=1>”);
</script>

In the present invention, when the online auction visitor loads an auction page in his browser, this code residing on the auction page executes inside the visitor's browser and, using a scripting language, assigns the Referring Document to a variable and sends that information to a script called, in this example, track.cgi.

(Note the use of the HTML tag <img> to accomplish the data transmission. An image is not actually loaded, nor is one intended to be; it's simply a method of getting the variable data to the track.cgi script.)

The primary reason the referring document is of chief concern is that it contains not only the previous page the visitor visited, but embedded within that URL is detailed information about the manner in which the visitor found the seller's auction, including search terms, categories browsed in, method of sorting, etc.

When a visitor 3(a-e) interacts with an online auction listings page, that interaction can be determined by examining the URL of the resulting listings page. By understanding how to decipher the contents of said URL, it is possible to know exactly what the visitor searched for, which categories the visitor browsed in and how the visitor sorted the resulting listings.

Since this URL becomes the referring document whenever a visitor views a seller's online auction page, and since in the present invention, this data is transmitted to an external server 4, it can now be aggregated into a database of typical search activity.

Whereas step one of the present invention is a method of recording and transmitting the contents of the online auction visitor's environment variables (and other pertinent data) to an external or secondary server 4, step two is the retrieval and aggregation of that information for later use.

Step two comprises a server 4 connected to the world wide web, with dynamic scripting capabilities such as CGI, perl, ASP, PHP (or any other scripting language that allows external variables to dynamically determine how a given script is executed).

In the preferred embodiment, perl-based CGI is used, although any scripting language (PHP, ASP, etc.) will suffice.

When the scripting code is rendered inside the online auction visitor's 3 web browser, it sends data to a script on server 4 called, in this embodiment, track.cgi, which parses the data and saves it to a log file.

The online auction sellers 6 can now access server 4 through any computer with a web browser installed, and load a cgi script called, simply for illustrative purposes, stats.cgi.

Stats.cgi opens the logfile(s) on server 4 and assembles the data being held in its log files and parses items that may be of interest to online auction sellers. These include:
Ranking (highest to lowest, or vice versa) of the most popular search terms used by auction visitors
Ranking (highest to lowest, or vice versa) of the most popular categories browsed
Ranking (highest to lowest, or vice versa) of the most popular categories searched in
Ranking (highest to lowest, or vice versa) the most popular search terms within specific categories
Ranking (highest to lowest, or vice versa) the most popular methods used to sort auction listings
etc.

Furthermore, as this data is recorded and assembled over time, the present invention will have the ability to display activity trends of online auction visitors. For example, if a search term used by only five auction visitors last month is used by 25 auction visitors in the current month, users may note the 500% increase and respond accordingly. The present invention offers as an additional ranking option, the ability to rank the increase and/or decrease in the popularity of all ranking criteria listed above.

In the preferred embodiment, the online auction seller is shown this data as an online website 5 that is dynamically generated by stats.cgi, listing all the available ranking options and allowing the online auction seller to choose the manner in which the aggregated data is sorted.

Another embodiment would constitute pre-assembling the data for a plurality of ranking structures and delivering that data in a single document. In this embodiment, the online auction seller can choose to view only those rankings that are of interest to him.

Another embodiment would constitute a web-accessible database that would allow a user to submit his own queries to said database and return the results most relevant to him.

As to a further discussion of the manner of usage and operation of the present invention, the same should be apparent from the above description. Accordingly, no further discussion relating to the manner of usage and operation will be provided.

With respect to the above description then, it is to be realized that the optimum configuration of the invention, whether it includes more or fewer ranking options, additional or less data, or whether it entails a variation in function and manner of operation and/or use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method of recording, aggregating and disseminating online auction visitor data, comprising:
a plurality of online auction sellers obtaining a tracking code;
a plurality of online auction sellers emplacing said code into the auction descriptions of said sellers' said online auctions;
upon said visitors visting said online auctions, recording said information about said visitors;
compiling, sorting and ranking said recorded visitor information; and
providing said online auction sellers with said compiled, sorted and ranked information.

2. The method of claim 1, wherein said information contains one or more of the following:
most popular search terms;
least popular search terms;
most popular item category;
least popular item category;
most active time of day;
least active time of day;
most popular sorting methods;
least popular sorting methods;
most active day of the week; and
least active day of the week.

3. The method of claim 1, wherein said information takes the form of a report containing one or more of the following:
popularity of search terms and/or phrases;
popularity of categories;
popularity of search terms and/or phrases within specific categories;
popularity of hour of the day;
popularity of day of the week; and
popularity of sorting method.

4. The method of claim 1, wherein said providing is accomplished via the internet.

5. A method of recording, aggregating and disseminating online auction visitor data, comprising:
a plurality of online auction sellers obtaining a tracking code;
a plurality of online auction sellers emplacing said code into the auction descriptions of said sellers' said online auctions;
upon said visitors visting said online auctions, recording said information about said visitors;
compiling, sorting and ranking said recorded visitor information; and
providing third parties with said compiled, sorted and ranked information.

6. The method of claim 5, wherein said information contains one or more of the following:
most popular search terms;
least popular search terms;
most popular item category;
least popular item category;
most active time of day;
least active time of day;
most popular sorting methods;
least popular sorting methods;
most active day of the week; and
least active day of the week.

7. The method of claim 5, wherein said information contains a ranked list of one or more of the following:
popularity of search terms and/or phrases;
popularity of categories;
popularity of search terms and/or phrases within specific categories;
popularity of hour of the day;
popularity of day of the week; and
popularity of sorting method.

8. The method of claim 5, wherein said providing is accomplished via the internet.

9. A method of recording, aggregating and disseminating online auction visitor data, comprising:
a plurality of online auction sellers obtaining a tracking code;
a plurality of online auction sellers emplacing said code into the auction descriptions of said sellers' said online auctions;
upon said visitors visting said online auctions, recording said information about said visitors in a web-accessible computer database; and
granting said online auction sellers access to said web-accessible computer database.

10. A method of recording, aggregating and disseminating online auction visitor data, comprising:
a plurality of online auction sellers obtaining a tracking code;
a plurality of online auction sellers emplacing said code into the auction descriptions of said sellers' said online auctions;
upon said visitors visting said online auctions, recording said information about said visitors in a web-accessible computer database; and
granting third parties access to said web-accessible computer database.
